(19) United States
(12) Patent Application Publication
(10) Pub. No.: US 2022/0332439 A1
(43) Pub. Date: Oct. 20, 2022

(54) DEVICE TRANSPORT BY AIR

(71) Applicant: George Alain Margescu, Bucaresti (RO)

(72) Inventor: George Alain Margescu, Bucaresti (RO)

(21) Appl. No.: 17/627,652

(22) PCT Filed: Sep. 16, 2020
(86) PCT No.: PCT/EP2020/075920

§ 371 Date: Jan. 15, 2022

(51) Int. Cl. B64G 1/00; B64G 1/42; B64G 5/00

(52) U.S. Cl. CPC B64G 1/002; B64G 1/428; B64G 5/00

(57) ABSTRACT

The invention relates to an aerial transport device by means of connections with supply lines and cables for the transport of electricity, liquids and goods, at the limit of the atmospheres of the planets, in areas with low gravitational attraction, so that the flight can take place in the formation. The aerial transport device by means of flight devices (A, A1n, B, Bn, A4) that are in motion and connected between them, characterized in that the system can supply (P1) and simultaneously transport physical objects, liquids, and energy (P) to and from the outer space of dense atmospheres (D) and to reach the maximum limit of the environment density suitable for space flight devices (A3) with aerodynamic load as well as for horizontal air transport (A4, A2, P, An, A3). The invention is technical device for transporting in space with flying devices and move in formation flight of at least three forming connections.

There is known a document (KR20070113934A) that refers to a hypothetical process of hanging and transporting through space a lift cabin between the planet Earth and the natural satellite, for the transport of water and cargo and to people, reducing the cost of transporting space rockets and classic satellites with the hypothetical resistance of the carrier cable. The proposals for the creation of a space lift system with counterweight located on the Geostationary Orbit of the Earth were hypothetically defined by scientist Konstantin Tiolkovsky in 1895 and by the writer Arthur C. Clarke in 1979 in the work “Fontaines du paradis”. Another system proposed for the transport of wind electricity by cables, from balloons raised in the tropopause (mentioned by Alvin Toffler, “Third Wave”, Chapter 12, “Peaks”, at the Romania, Politics Publishing House, in 1983).

The document (WO2016170951) refers to a process of transport of fine droplets, of liquids, on a relative distance in air under reduced pressure, on a trajectory, through controlled vibrations of some machines without connections between them;

It is known the document (WO0161188A3) that uses flying machines of the special type with “rotary shape”, with cross engines combining the different types of combustion and propulsion crossed according to the physical theorem of inertia, of “Huygens-Steiner”;

There are also known two fuel supply systems, with liquid fuels, between tankers, as: “flying boom” (system with arm and rigid hose) and “hose-and-drug” (system with mobile hose and catch basket) used on McDonnell Douglas KC10, Pegasus Boeing KC46 (767), Ilyushin An Il-78M and Boeing KC 135 Stratotanker, Airbus A330 MRTT-powered robotic aircraft, Myasishchev VM-T Atlant and others.

It is known that: the companies “Northrop Grumman Corporation”, “Defense Advanced Research Projects Agency (DARPA)” and “NASA Dryden Flight Research Center”, in their test of 2011—(Northrop Grumman's Proteus), made with two autonomous airplanes (NASA Global Hawk), flew without pilots near each other from 13 m distance and at an altitude of 13.7 km, setting a record through the fuel test between two airplanes of the same type, without pilot, (type “buddy-to-buddy”), without a tanker plane, together with the hose-and-drogue system, with hoses that in other planes far exceed their fuselage, depending on their size- and capabilities.

In 2014, the company “Northrop Grumman Systems Corp.” expanded the operations for refueling “X-47B jet” drones through the US military.

It is also known that in 1960 three American navy aircraft were powered together forming a flight in formation as a “chain”.

In year 1958, the record recorded by two people who fueled a speeding motor vehicle, a private Cessna 172 aircraft, which ran 65 days without landing, is notorious in the USA.

The X20-X37, “MiG-105 Hurricane” and “Dream Chaser—Nevada” reusable aircraft are used since 1960 for descents between altitudes from 500 km-40 km, have thermal shields with resistances up to 1,400° C., and they were made to be able to transport fuels for stars and human crew, to the Earth's Low Orbit, in case of emergencies.

The document is known (U.S. Pat. No. 9,085,897B2 also published as WO2008101346A1), which describes a fixed, floor-mounted, ground-connected inflatable tower, approximately 20 km high, which is used for the operation of an elevator towards a faster launch and landing ramp for scientific space flights and travel.

The technical problem that the invention solves consists in grouping for a longer period technically (in accordance with the environmental conditions: wind, temperature, air density, meteor dust, gravity), of at least three flying vehicles, regardless of their dimensions and regardless of the types of fuel, vehicles moving in the air, and through these groups, to transport at increased altitude the various materials or liquid fuels (or similar to the transport through an elevator, to the interplanetary space), by reducing the travel time the distance to space, by reducing the gravitational effect and the classic transport costs (such as rockets with chemical combustion engines and balloon transporters with satellites or platforms).

The air transport device at an altitude that is realized by a formation flight of at least three identical or hybrid motorized flight devices, which are connected to each other to feed, support and transport each other and to make a transport system of electricity, light rays generated by high-capacity light-emitting diodes, liquids or goods (physical objects through a crane or lift), to the outer space of atmospheres similar to the terrestrial one, eliminates the disadvantages presented above by helping to reduce costs of space transport to areas with low gravitational attraction, up to the limit of the density of the environment conducive to the flights through the lift (“Coanda effect”), and at the same time supports the flying devices in the form of a grouping depending on the meteorological and geo-physical period of the planetary environment for different periods of time and altitude. In general, planets with atmosphere hold approximately aproximativ ¾ of water vapor up to an altitude of 20 km, as is the case with planet Earth. Thus, in the troposphere, (M, FIG. 1), there is 95% of water vapor. Thus the resistance to the advancement of known flight units, consuming much fuel up to these altitudes compared to the final mass transported. To counteract the gravitational force of the planet, this force si diminished with the efficient acceleration by rotating at high altitude of the devices (starting over 6 km altitude), at speeds tending to a minimum of 28,983 km/h. But the gravitational attraction is diminished in the case of the Earth by 95% at a distance of about 408 km altitude, which helps the constant orbiting of the recipes, cosmic shuttles, satellites and orbital stations.

In the case of the planet Mars due to its mass and different rotation, the gravitational attraction is 38% lower than that of the Earth. Thus, known and recently sent flying vehicles have made it easier to cope with the attraction of Mars. An Mars altitude transport device being at the advantage of the Earth, by its shorter length. But the rarefied atmosphere of the red planet, a disadvantage in front of the load of classic vehicles. Thus the balloons and the blades of the engines or the circumference of the vehicles and the speed of flight, are correspondingly proportionate to Mars, here the atoms being easily removed from the atmosphere, due to the reduced activity of the magnetosphere. Thus the atmosphere of the planet Mars has only 11 km, being very small compared to the one of the Earth's mesosphere up to 90 km (variable to poles). Wind speeds vary and interact in the Martian ionosphere directly with outer cosmic winds, with temperature differences similar to those of the Earth's cold mesosphere (between −110° C. and +70° C.), accepted by flights with known vehicles. In the terrestrial tropopause, in spring, at 25 km altitude, near the equatorial area (Florida), winds of 118.8 km/h (33 m/s) are recorded, and in the northern hemisphere near the temperate-continental zone (Mountain Postavaru), the winds reach 208.8 km/h (58 m/s) in spring. The highest, in the thermosphere, the winds reach up to 750 km/h (208 m/s), and at temperatures of 2000° C. Temperature guard causing vertical and horizontal particle movements.

At more than 30 km altitude the pressure of the atmosphere drops significantly compared to that of the sea where flights over 1224.8 km/h (approx. 1 Mach) take place, depending on the temperatures, the speed of sound being propagated differently.

Helium balloons reached heights of about 65 km from Earth's atmosphere. “Red Sprites” luminous discharges from the troposphere (between 50-90 km), were recorded around the meteorological balloons and have the effect of the rare encounter above the storms created in cumulonimbus clouds, with no effects recorded on the aircraft that are not connected to the ground.

For the mesospheric launches (M. FIG. 1), of over 80-90 km, the rains of meteoric dust are predictable in advertised periods of the year with maximum meteors of 15 days/year, being variable only for the months with meteors generated during the “Leonide” and “Orionide” periods, with dust speeds up to 234000 km/h (650 m/s).

Above the jurisdictional altitude of the states, theoretically 100 km, the “Karman line”, are used for liquid motor flights (missiles, X15 airplanes, from 1960 or airplanes with engines, ramjet, with speeds up to 6 mach), without restrictions of regional pollution.

According to the US Air Force calculations, refueling air in airplanes reduces the cost of airfares to airplanes by 35-40% for every 3500 km traveled compared to the power supply of the same aircraft from the ground, thus saving the costs of taking off with the tanks. heavier with fuel.

In commercial flights the distance between the antennas on the aircraft fuselage warns the flight as dangerous below the minimum separation distance between 300 m (1000 ft) aircraft, but for military air refueling the hoses also have lengths between aircraft, over 13 meters.

In the case of external mobile departing flights, such as communication pipes or cables, as well as the attached counterweights, they follow the same direction with the vehicles carrying them, opposing the resistance similar to the force of the external winds, with that of the flying vehicles. The verticality of the pipes and cables will be maintained and if the flights take into account the gravitational force of the Earth on cables and hoses over 600 m.

The proposed hose-and-drug coupling system with hoses and chimneys between aircraft already has automatic hose retraction systems in addition to rotating motion compensation systems between aircraft or air turbulence.

In the case of military conflicts, a highly developed nation operates with concomitant air forces of about 40-50 different military aircraft, proving that the world and local economy can sustain fuel consumption corresponding to several months duration similar to the theaters of modern technological operations, generating in plus and consistent economic exchanges on the horizontal, between the air service operators.

It is known that when returning to the atmosphere space shuttles (Atlantis, Buran, Colombia, Discovery, etc.), need to reach from speeds of 27,680 km/h to under 1 speed, computer flight maneuvers, descending, from the less dense atmosphere that prevents the shuttles from stopping, towards the atmosphere with the increased density from about 122 km altitude (between the thermosphere and the mesosphere bays), with the following maneuvers: lifting the shuttle's nose to an attack angle of 40 degrees in the direction of gravity, but at the same time with successive turns to the sides of the shuttle at exact angles, “snaking”, to avoid overheating or rejecting the dense atmosphere of the planet. At the return these types of shuttles not having fuel tanks for speed reduction, but through these computerized maneuvers can reach the normal speed level of refueling planes circulating in the stratosphere, tropopause or similar planetary environments. By means of the transport and feeding device at altitude, the shuttles described, upon return, will now be able to have sufficient fuels for braking when returning from the atmosphere with the help of engines at the stratospheric level.

Flying aircraft known as helicopters and drones that benefit from the air density, can pass into the northern hemisphere, in Romania from the level of the Postavaru or Moldoveanu mountains, as well as from the highest mountain from which a helicopter has stationed and taken off so far, that is, on Mount Everest at 8932 m altitude (the record being recorded in 2005 with a Eurocopter AA3500B3), and the highest flight with a helicopter (SA315 BLAMA), was obtained by lifting up to 12441 km altitude, in 1972. Altitudes three times higher than on Mount Everest are on the planet Mars, on “Olympus Mons” which has 21,230 m altitude being the highest mountain in the Solar System.

The highest human-operated hot air balloon rose to about 20 km, and up to 40.3 km semi-automatic and parasailed (belonging to the Google group—Alain Bustache). The meteorological balloons rose up to 65 km altitude, containing technical installations attached.

For the Earth, prototypes of airplanes are used that can be refueled efficiently with solar energy starting from the altitude of 40 km.

For scramjet engines with speeds between 5-14 mach, with hydrogen and oxygen combustion there are prototypes for interplanetary areas and it is proposed in areas with dense atmosphere of planets known as useful for formation flights. The initial solution of the “ramjet-bassard” engines with funnels (for the capture and reuse as propulsion of hydrogen molecules, where the densities in space reach up to 1 atom/cm3.), Being viable even in the case of group flights between aircraft.

The following advantages are obtained by applying the invention:
the costs of transporting rockets with solid or gaseous fuels are reduced,
The same transport cables are used to transmit liquid fuels or electricity, at the same time with the transport of physical objects at different altitudes with the flying equipment of the formation.
the objects and liquids transported, the static charge or the lightning, or the dangers of fire or electrocution from the troposphere without being connected the flight formation of the magnetic, negative surface of the ground can be exempted from accidents;
the aerial device can avoid the unexpected winds through the radar systems compared to the space elevator systems with an inflatable tower.
the aerial device can withstand the electrical discharges from the tropospheric or higher layers “lighting sprites”, with resistances up to 11000 kwolti compared to the geostationary or inflatable space elevators.
the aerial device can have the installation of the “discharge plugs” of lightning against other terrestrial constructions;
the air transport device can cope with commercial aircraft with positive electric lightning at altitude, which occur on planets like Venus, Mars, Jupiter, these phenomena being up to 100 times more powerful, but 80 times rarer than those from Earth.
With this transport system, water can be transported along with other ethyl alcohols such as: ethanol or antifreeze combinations that do not freeze at the transport by storm in certain concentrations. The water can be redistilled at altitude and recomposed. Also, the hoses or transport containers from the lift cabs transported by cable with heating systems.
With this transport system along with the liquids can be transported on the same pipe through it, other containers as physical objects.
via the device can be used reusable shuttles that in turn can feed or transport other satellites low orbit located between 150-200 km altitude of Earth;
the Aryan transport device is resistant to high winds and hurricanes and can be grouped according to the favorable flight area as a classic aircraft race compared to the lift system with inflatable towers that require a lot of time for hurricane replenishment;
the system can be docked at the same speed as that of a cosmic shuttle entering the dense atmosphere of a planet without it having to reduce its speed to zero as in the case of decks on inflatable lift towers.
it does not influence the existing air corridors the formation flights taking place mainly in the hemispheres areas where the low density of the atmosphere can be reached at lower altitudes, thus the formation flights being reduced in height to the limit of the supply with the cosmic shuttles;
For this system, several flight corridors are reached, but several airports are involved for fuel tankers, being economically involved in several countries, avoiding the monopoly of space transport, increasing the general economic interest.
This transport device at altitude is reused for years compared to the classic missile systems that half can no longer be recovered qualitatively from the oceans, and the other half are lost in orbit creating cosmic garbage very dangerous for missions.

The following are examples of embodiments of the invention in relation to FIG. 1, which represents:

FIG. 1, representation of a flight on the surface of a planet, Earth, of a flight in formation of at least three planes that feed each other at different altitudes depending on the season and the rotation forces of the planet, with geographical indications;

FIG. 1, point “P1” refers at the same time to the supply hoses as:
conical hoses with a large base for arm boom (“flying boom”), used more efficiently for refueling in aviation,
conical rails with a large base for feeding, which have at the end a plug provided with in-flight coupling basket (“hose-and-drogue”);
FIG. 1, point “P” also refers to power cables such as:
Electrical,
light beams generated by laser diodes and for the capture of “solar energy”,
drop column transmitted by vibration under pressure of 10 thousand Pa,
cable for transporting physical objects, metallic, from Kevlar M5 or resistant polyethylene fibers;
FIG. 1, point “A2” represents a “tanker” type aircraft, for transporting liquid fuels, electrical resources (atomically, thermally or solar powered), physical goods, in the atmosphere of a planet, which will feed in flight;
FIG. 1, the points “A”, up to “An”, represent “tanker” type aircraft, for transporting liquid fuels, electrical resources (atomically, thermally or solar powered), physical goods, in the atmosphere of a planet, which feeds at speeds below 1 Mach in the atmosphere of a planet;
FIG. 1, the points “A1”, up to “A1n, A3, D”, represent “tanker” type aircraft, for transporting liquid fuels, electrical resources (atomic, thermal or solar powered), physical goods, in the atmosphere to a planet, which feeds at speeds over 1 Mach;
FIG. 1, the points “B”, up to “Bn”, represent flight devices of the type of gas balloon, electric drone, helicopter, rotary plane, for the transport of liquid fuels, electrical resources (atomically, thermally or solar powered), physical goods, in the atmosphere of a planet, which feeds at speeds below 1 Mach in the atmosphere of a planet;
FIG. 1, point “A4” represents a “tanker” type aircraft, for transporting liquid fuels, electrical resources (atomically, thermally or solar powered), physical goods, in the atmosphere of a planet, which will supply in-flight and it is connected to an “M” point at the earth's table, under certain weather conditions.

The superimposed aerial device, for transport in space, that is, grouping for as long a period as possible, (in accordance with the environmental conditions: wind, temperature, air density, meteoric dust, gravity), of some vehicles (from the state of the art) of different sizes and with different types of feed in motion in the air, according to the invention, in groups of at least three vehicles with aerodynamic load, uses a flight of devices connected in the group, which are used for the purpose of transporting at high altitude of various materials, similar to a lift to the interplanetary space, by reducing the distance and transport costs, by reducing the gravitational effect. In order to achieve this grouping, according to FIG. 1, the “tanker” type aircraft A2, A4 that carries liquid fuels, and electrical resources with diodes (atomic, thermal or solar powered), plus physical goods, in the atmosphere of a planet, feeds into fly and unite at least three airplanes in type A formation up to the Year (representing at least the third grouped aircraft), which are used for transport being connected to each other and fly at speeds below 1 Mach (up to 1224.8 km/hour). In FIG. 1, the aircraft A to An are flying devices with connected fuels that fly at speeds of more than 1 Mach in the atmosphere of a planet, which supplies other devices with liquid fuels, and electrical resources with diodes (atomic or solar). or carry physical goods. In FIG. 1 the B to Bn aircraft (which is a minimum of the third grouped flight apparatus), represent hot air balloons and, or, electric drones, freight helicopters, or “rotary” devices with “Steiner” engines, which flies in formation at speeds below 1 Mach in the atmosphere of a planet, which supplies various devices with liquid fuels, with electrical resources with diodes (atomic, thermal or solar powered) and transports physical goods. The aircraft A1 to A1n (which represents at least the third flight apparatus, in FIG. 1), are flying devices with liquid fuels or electrical resources with diodes (atomic, thermal or solar powered) and for transporting physical goods flying at speeds above 1 Mach (over at 1224.8 km/hour), which feeds and is connected between them flying in a concentric direction to return to the same place connected, with the slower flying aircraft, from another formation, over a period of time calculated to compensate for wind speeds from different altitudes. At the level of the terrestrial troposphere, from 10-18 km altitude, the winds reach over 700 km/h in summer, the type A1-A1n aircraft succeeding by increasing the speed to compensate for the turbulence and to maintain as much shape as possible for flight safety, and in such a way that the feeding periods will be sufficient for the autonomous flight, but also the transport to the devices from higher altitude. Aircraft type A1-A1n, A3 compensates by monthly scheduling of group flight different periods of meteorological rainfall over areas with similar density to the Earth's mesosphere, at 80 km altitude, dust generated, for example, in a year of months with “Leonide” and “Orionide”.

In FIG. 1, the A2 and A4 tankers are flight devices flying at speeds below, or above 1 Mach in the atmosphere of a planet, which connects with the higher aircraft as grouped altitude (A2, A-An, B-Bn, A1-A1n), supplying and transporting.

The A2 tankers take off and avoid the electric discharges from the atmosphere of the F electrons, when they are connected with a group of A-An, or B-Bn, A3 flying devices, making contact with the ground M avoiding the formation of lightning.

The A4 fuel station devices have a concentric flight being permanently connected to the earth stations that have M earthings, to compensate for the electric F discharges.

The A4 fuel station apparatus with M grounding, are connected in favorable weather conditions with A2 tank devices without grounding, only when the tanker carrying in flight is not connected with devices that fly in formation of at least 3 A-An, B flight devices. −Bn, A3 that have static charge due to the lightning F in the atmosphere, avoiding the dangers in the transport of liquid fuels or physical objects or with electrical resources with diodes (atomic, thermal or solar powered).

Devices A3, FIG. 1, space shuttle transport type, which fly concentrically, connect to devices A1n, A1 which are flying devices with liquid fuels or electrical resources with diodes (atomic, thermal or solar powered), physical goods and which are connected between them and fly in a concentric sense, to return to the same place with the devices flying in the forward direction An, A, A2, A4 or Bn, B, A2, A4, in a period of time, which is the equivalent of the flight forward direction (flying at speeds above, or below 1 Mach), feeding and transporting at the same time or separately, depending on the air jets, but maintaining the same formation at one time. Flights are manually piloted or remotely controlled electronically. Electronic assistance also avoids heavy flights in the A4, A2, A-An, B-Bn, A1-A1n formations, through cumulus cloud areas with various F weather phenomena, most often occurring between 0 km and 20 km in the troposphere. Earth.

On FIG. 1 the A3 flight devices are space shuttle flight devices for liquid fuels transport, physical goods, electrical resources with diodes (atomic, thermal or solar powered), which fly in the atmosphere of a planet that begins to have the necessary aerodynamic load. of the wings of a flying machine called “Coanda Effect”. At the return of the shuttles on Earth, the dense atmosphere starts from about 122 km, up to zero km altitude with variations in different seasons and allows the A3 space ships, supporting the reentry into the denser atmosphere of more than 1 hydrogen atom/m3, plus other gases. dense, to feed from other flight devices such as A1n-A airplanes, balloons, “rotary-shaped” aircraft with “Steiner” engines, Bn-B, A2, A4 helicopters carrying various P, P1 materials.

On FIG. 1, after feeding the space shuttles A3 from the lower shuttle as altitude A1n, A1, from bottom upwards, this A3 accelerates with engines of the type “Coanda reaction”, or ramjetb or chemical engines, towards the outer environment of the dense atmosphere of the planet. with maximum fuel and load, after disconnecting from a formation of Bn-B, A2, A4 flight devices, depending on the specific temperature guard of the planet of the mesosphere, stratosphere, or tropopause, the connection over these altitudes being made between A3 aircraft. with satellites or cisterns D, which travel at speeds over 28,000 km/h in the outer orbit of the Earth, towards the second part of the mesosphere, towards the thermosphere or exosphere, that is over the “Karman line” (the legal altitude of 100 km).

The fuel is necessary for the refueling as close as possible to the mesosphere of an A3 shuttle—so that it can overcome by the centripetal force the gravitational attraction of the Earth, at a speed of about 28,500 km/h until the altitude of about 408 km, corresponding to the connections with the closest space stations, known today, FIG. 1, D, or other satellites in the low Earth orbit, −30% to 50% amortize the costs of flying from the ground, supplementing the transport of physical goods at the same time between A3 devices, A-An, A-A1n, A3.

The speed of the power supplies in operation have an average of 500 km/h sufficient to maintain a flight in formation from A2, A-An, A2 or drone planes, balloons, B-Bn, FIG. 1, (or combinations between these types of engines), up to the boundary of the Stratosphere, at 50 km altitude, for Earth and about 11 km for the planet Mars. After this attitude the flights to the Mesosphere can be made in formation with supersonic vehicles A1-A1n, A3, in connection with the other formation of devices A2, A, An Bn, FIG. 1, the temperature gradient varying in the hot mesosphere (32 km-60 km altitude), from +30° C. to, −40° C., −80° C., towards the cold mesosphere (up to 85 km altitude).

The supply hoses between the aircraft, with connecting elements contain systems such as: “flying boom”—system with an arm as a rod containing hose covered with rigid material; and “hose-and-drogue”—a system with mobile air hose and end connection for the lower altitude aircraft. Air transport device for space A2, A4, A-An, B-Bn, A1-A1n, A3 uses for conical hose supply with large base, as a counterweight P1, covered with solid arm, with “Boom refueling” connection for the aircraft of low altitudes. In parallel or simultaneously between the aircraft, a conical hose supply system with a larger base is used, as a counterweight P1, with connection with “house and drug” funnel A2, P1, A4, P1, A, P1, An, B, P1, Bn, A1, P1, A1n, P1, A3.

In the flight of the devices conceded between them the atmospheric pressure decreases rapidly with the altitude. The atmospheric density also decreases with the altitude, at only 3 km altitude the air density decreases by about 30% compared to the ground, which is about 1 kg/m3, the pressure being more efficient for flights over 1 mach, of 1224, 8 km/h, at +25° C. The speed of the devices in formation can be even lower to reach the speed of sound now at 1,076 km/h at the temperature from −50° C. with flight devices A1, A1n, A3, FIG. 1, connected through the supply systems for example of type “flying boom refueling” (system with arm and short rigid hose), system that can transfer liquid fuel faster at altitude, about 2700 liters/min.

The similar system for the supply in the mesosphere is that of the liquid transfer “buddy-to-buddy refueling”, on more than three flight devices A1, A1n, FIG. 1, system of feeding of airplanes of the same capacity, that is to say, without feeding of tankers of type A2, but the transit time of liquids (such as liquid nitrogen and oxygen, Kerosene, water, ethanol, their derivatives or combinations) through the P1 conical hoses, are higher than the “flying boom” power supply (arm system and rigid short hose), but safer for high wind speeds of about 500 km/h and increased negative temperatures in altitude formations A1, A1n, FIG. 1.

The turbulence between devices A2, A4, A-An, B-Bn, A1-A1n, A3 is compensated by the P1 hoses whose materials are elastic, but with resistance to breakage (similar to nanocarbon or synthetic fibers “Kevlar M5”) and have At the same time, retractable hose clamps supplemented with springs that dampen the differences between the altitude flight apparatus and the lower altitude aircraft, and by compensating, by rotating these clamps with additional hose lengths, retractable hinged cleats. computer.

1f) The tanker plane A2 which supplies an airplane A which in turn supplies another airplane A, up to a minimum of 3 airplanes, An, A1, A1n, all powered by means of hoses P1, have in parallel or separately connected different connections P, which represents depending on the flight requirement: metal cable, electric cable, light rays generated with diode electrical resources (atomic, thermal or solar powered), or, liquid stream transmitted linearly through vibration devices.

The tanker plane A2 which supplies a flight device B which in turn supplies another device B, up to a minimum of 3 flight devices, Bn, A1, A1n, all powered by the P1 hoses, have different or parallel connections between them. P, which represents according to the flight requirement: metal cable, electric cable, light rays generated by electrical resources with diodes (atomic, thermal or solar powered), or, liquid stream transmitted linearly through vibration devices.

Feeding directly from the ground with groups of devices P1-P-A4, P1-P-A2, P1-P-A, P1-P-An, P-P1-B, P1-P-Bn; P1-P-A1, P1-P-A1n, P1-P-A3 can be made at the altitude of the mountains such as over 1.7 km in the Earth's troposphere, in the Northern hemisphere and in the depopulated areas, or zero km, over the oceans.

In the case of the aerial transport system by tanker A4, A2 to the flight apparatus with “rotating shape” according to the physical theorem of “Steiner” which combines the different types of cross-reaction forms of combustion, to overcome gravity, (also known as the theorem).

Huygens-Steiner or the parallel axis theorem being used in mechanics and allows the calculation of the moment of inertia of a rigid solid with respect to an axis, knowing the moment of inertia with respect to an axis parallel to the first and passing through the center of mass of the body), the theorem described and in document WO0161188A3, the connection is made through hoses P1 to the flight apparatus with the “rotational shape” of higher altitude B, Bn, and then to the devices A1-A1n, A3, FIG. 1.

In the air transport system of the tanker type A4, A2, the connection is made by the P1 hose and by the droplets of droplets of fuels and other liquids under reduced pressure realized in the upper atmosphere of the planets (and with a small number of molecules in the air), generated. of vibrations as a column of liquid P (drop column transmitted by vibration under pressure of 10 thousand Pa according to document WO 2016170951), between the A-An aircraft or B-Bn aircraft, up to the high altitude aircraft A1, A1n, A3 FIG.

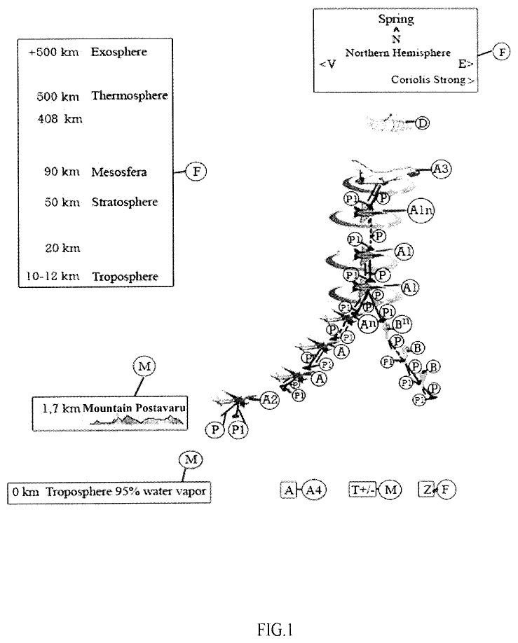

In the case of the air transport system of electric type aircraft with solar charge and devices with electric accumulation A2, to the flight devices A-An, An-A1n, A3, FIG. 1, the connection is made through the electrical cables P, In the case of the aerial system of electric transport type aircraft with propellers (drones, helicopters), with solar charge and electrical accumulation A2, the connection is made by the electrical cables P between the devices of type B-Bn, A1-A1n, A3, FIG. 0.1, all with solar charge.

1f) In the case of the aerial system of electrical transport of aircraft type fuel tank plus electric generator A4, A2 the connection is made through hoses P1, plus the electric cables P between the airplanes of type A-An, An-A1n, B-Bn, A3, FIG. 1.

In the case of the aerial system of electrical transport of aircraft type with fuel, plus electric generator A4, A2 the connection is made through hoses P1, plus through the light beam realized by laser diodes P, between the airplanes of type A-An, An-A1n, B-Bn, A3, FIG. 1.

In the case of the aerial system of electrical transport type aircraft with atomic generator A2, the connection is made through the electrical cables P, plus through the hoses P1, between the devices of type B-Bn, A1-A1n, A3, FIG. 1.

In the case of the air transport system of the tanker type aircraft with fuels A4, A2, A3, FIG. 1, plus P cable of ferrous materials, synthetic fibers “Kevlar M5” with nanocarbon, from which are attached physical objects self-supporting forming a lift, on which they ascend or descend as a crane of weights between the different types of flying equipment from the formation from altitudes. The connection is made through hoses P1, plus the cables that raise P between devices A4, A-An, An-A1n, B-Bn, A3.

And in the case of the air transport system with tanker type A4, A2 with balloon or slow-moving drones B-Bn, A-An, the connections of the P1 hoses or the cables and the P-beams are made by rotating at the appropriate speed of the aircraft. necessary speeds in the turbulent zones A4, A1-A1n, A3 FIG. 1, around the axis formed by the column of slow flying devices.

1f) P1 liquid fuel hoses have a minimum of 13 meters in length on the aircraft to be easily controlled from 13 km altitude, and to use the Coriolis force of the Earth's motion hoses and cables, in the northern hemisphere, for this purpose. from V to E, FIG. 1, the power cables are over 600 meters long in order to be deflected “right”, to E (in the direction of the northern flight) and to keep the hoses between the P1-P-flight devices constant, vertically. A4, P1-P-A2, P1-PA, P1-P-An, P-P1-B, P1-P-Bn; P1-P-A1, P1-P-A1n, P1-P-A3, if the aircraft have a sense of movement from V to E, on Earth. To the north the howitzer pulled over 600 m will retreat to the right at E, and to compensate for the Coriolis rotational force of the planet, it must be sent a few degrees to the left, at V, to the desired trajectory, to keep its direction. the final. In the same case, the connections of the P1 hoses and the physical wires P, FIG. 1, between the flight devices A2, An, Bn, A1n, A3 use this Coriolis force to stay upright and to keep a greater distance between the flight devices, by their length, thus reducing the number of flight devices, and increasing the altitude of the flight column. In the case of the re-entry into the atmosphere of the A3 space shuttles, they also return to the East in the sense of the Earth's force, so that there are no infractions and incalculable deviations. And the space satellites D, FIG. 1 and the International Space Station (ISS) D, orbit avoiding this rotational force of the Earth, blurring the undercurrent and losing altitude from about 408 km, depending on the danger (oval direction), of rotation around the planet. which will be accessed by the A3 tank devices.

Also, to maintain the verticality of the supply and transport hoses other P1 liquids, they will have a larger shape at the bottom and as a counterweight to get as close to the connection of the lower flight apparatus as altitude from formative, geometrically being compared with a cone trunk. Thus, if the hose is like a cone trunk and will be regarded as a geometrical body obtained when sectioning a rotation cone through a plane parallel to its base, the following calculation relation will be considered:

V=⅓π·h(r₁²+r₁·r₂+r₂²);
where:
r1—the radius of circumference of the lower base;
r2—the radius of circumference of the upper base;
h—height of cone trunk.

Thus the volume of the hose (V)=7.79 m3 (˜7 tons kerosene). For a 600 ml conical hose (h) with a width of 4 cm above (r2), plus the radius of the lower circumference, being 20 cm wide (r1).

The descent and the climb from an altitude of a flight apparatus A2, A, A3 for servicing or breaks, from the formation, will be done by leaving the chain from the upper level A-An, A1-A1n, by retracting the connections P, P1, deceleration and the descent to the back of the apparatus column, the column which at a later point will allow it to be reached so that the detached or replacement device enters the formation near another flight device A, A1n. The other devices in the band will take altitude in case of necessity compensating the space left between the band in the band. Identically, for the formation of a flight device, drone with propeller or balloon B, it will exceed the constant speed of the column and will reenter as in a chain, in formation for refueling next to another B-Bn device, the procedure of flight repeating itself using radar telemetry technology.

Airplanes replaced by ground or A2 power supply are connected to airports along the entire flight path of the planet, generally maintaining constant flight direction to E in the direction of Coriolis force.

Commercial and military aircraft with large tanks, with engines operating on the “Coanda reaction principle” A4, A2, A, A1 in the flight up to a maximum of 11 km altitude, with a maximum of only 0.78 mach (and experimental aircraft with X-jet engines). −51A, Mig-25 Faxbat, fly up to 18 km altitude, with maximum 5 mach, and those withdrawn x-15, x-41A, Falcon HTV-2, SR-71, with speeds of about 7.2 mach). These tankers, with engines with the “Coanda reaction principle”, can maintain altitude close to the 100 km limit, with the “Karman line”, through P connections and with P1 hoses, which transport in parallel resources such as those from hydrocarbons, plus oxygen and liquid hydrogen required for the engines of the A4, A2, up to An, Bn, A1n, and high-capacity A3 and D rocket shuttles, through temperatures similar to +70° C. hot and cold Earth's mesosphere. fluctuates near the 80 km altitude limit, at −110° C.

Air transport device at separated altitudes, A2 tankers, statically loaded F, of the formation of at least two, or three and even more A-An, B-Bn flight devices, connecting with A4 fuel station flight devices. with earthing M, FIG. 1, which forms a concentric flight at high speed, maintaining the position of the forward flight, connected P1, P.

Another example of the invention through the in-flight power supply systems, the “flying boom” (system with arm and short rigid hose), which can transfer approximately 2700 liters/min of liquid fuel at lower altitude, into the Tropsphere. The “hose-and-drug” system (system with long movable hose and clamping basket, approx. 13 m), can transfer 700-900 liters/min of fuel at high altitude at the boundary of the Stratosphere, the clamping system between airplanes requiring more plenty of connection time, but more secure in turbulence. The latter, “hose-and-drug”, noted with the letter P, in FIG. 1, can be extended to over 600 meters, thus making Coriolis force felt when operating the A2, A, An, A1, A1n, A3 from East to West in the Northern Hemisphere, the Earth, which will help maintain the position of the hoses in the flight against the winds, being vertical and distant at the connection between planes.

The P-type cords will be connected in this case, in order to extract the fuel to the higher altitude, to the devices of the type An or Bn or A1n or A3, that is, in the opposite direction of the current supplies (from the upper plane to the lower one).

Due to the eventual turbulence, the devices will be connected as much as possible to maintain the fuel from the altitude with fuel or energy, the average connection through a “hose-and-drug” system being about 10 minutes in the troposphere with the possibility of reconnecting band.

For a Boeing 747 the flowing (feed) speed of the fuel in the wings is 2 tonnes/minute and consumes 0.2 tonnes of fuel/minute operating in parallel with the fuel loss operation. To eliminate, for example, 77 tons of fuel in operation, the plane needs 35 minutes. A Boeing 747 consumes 12 tons of fuel/hour, in normal air operation. By analogy it can be used for extraction the speed of movement of the flats for climbing the fuel through vacuum tubes from four altitude devices.

A Boeing 777-200 has a maximum capacity of 117,340 liters of fuel with approximately 9,700 km maximum flight autonomy. To power a Boeing 777-200 in the air (at temperatures up to +200° C.), through the long hose system starting from 13 m “hose-and-drogue”, at 900 liters/minute, it takes 130 minutes, that is 2.17 hours. Thus, to start a system consisting of a system of at least one Boeing 777-200 tank aircraft noted in FIG. 1 with A2, with another Boeing 777-200, FIG. 1, A, 50% of the aircraft flight is required A2 ie 4850 km, enough for refueling with half of the fuel of A2 to a type A. Or balloon type B which in turn will feed another minimum 3 devices An, Bn, A1, A1N, A3, FIG. 1.

It is known that for a classic rocket flight into space, they were used only for the stage with THREE flight stages—that is, to reach the Earth's low orbit (LEO)—liquid fuel tanks (such as: nitrogen, helium, hydrogen and oxygen liquids, kerosene or combinations), in quantities of 325000 liters (716502 lbs) for “Saturn V-USA” or similar for “N1-USSR” recipes. With standard, liquid fuel rocket engines. The useful weights carried with these types of engines are 5% (five percent), of the total weight of the mass of the missile fuels.

The only advantage in terms of fuels through the costs of sending shuttle space through this altitude device is up to 70% more efficient/launch compared to the costs of ground-level rocket launching, as well as through the diversity of transports.

So, for a continuous, minimum connection with, the 6020 km (10 hours) cruise, operating with Boeing 777-200 aircraft, to a liquid transfer through the hose-and-drogue type (900 liters/it takes 10 minutes to fill half of a tank, of connected devices of type A, An, A1, A1n, and finally the tank of a space shuttle type A3 of FIG. 1, that is to say 58670 liters (129345 lbs), fuel. The filling time can be increased according to the weather conditions. This means that in 10 minutes, 27.7% (˜¼) of the 325000 liters (716502 lbs) tanks, liquid fuels (kerosene, oxygen and liquid hydrogen), needed for the intermediate, TREI stage, are filled. classic missiles—mentioned, of the type “Saturn V-USA” or “N1-USSR”- to obtain the speed of orbital flights (28,000 km/h, at the ideal altitude of 191 km in the Delta-V angle corresponding to the appropriate danger from the poles of the planet).

Thus, for the 10-hour operation of the aforementioned aircraft, type A2 FIG. 1 the fuel costs reaching for a kerosene tank of 117340 liters, or 2 $/liter, for a total of 234680 $. And for the proposed fuel system with hoses and couplings between aircraft, type “hose-and-drug”, of 600 m, between the upper limit of the troposphere and the warm stratosphere, up to 50 km altitude, 83 devices will be required of flight mentioned A2 or A, An, FIG. 1, that is to say 9777942.2 liters of kerosene, totaling $19.55 million, for 10 hours of operation of all the devices (and for 1 hour of operation with all the priming of the system of airplanes in group the cost of fuel being 2.17 million $), the device can be reused, compared to the missile system already in the state of the art, which are lost in space after a single use, reusing only the tubes of the tanks in the first TWO stages of flight.

The cost of the transport device at altitude if purchased from “zero” (and will consist of 83 Boeing aircraft of $104 million/piece), can reach the above example (plus fuel), at 8.69 Billions of dollars, the device being reusable. The combined liquid hydrogen, used for a 325-tonne fuel tank for a Saturn V-US recipe (for a 6-minute pass at LEO's TREI stage), totals about $325,000. Of which the total costs for three fuel tanks/launch are approximately $3 million.

The fuel is consumed up to an hour. But the maximum budget for 1966 of a single Satrun V-USA missile, with four stages of tanks, being estimated today at $1.16 billion, the tanks being completely reused. The entire project for 11 missiles is estimated at $6.4 billion.

In conclusion, the above-mentioned aerial transportation device, totaling $8.69 billion, reaches more than half the costs of launching a conventional Saturn V-US missile program ($6.4 billion), but the advantage is increased, by reusing the air transport device type A2, A, An, A3, from FIG. 1, is done for decades, compared to the short life span of a classic rocket.

For a re-launch and return space shuttle system (Atlantis, Discovery this decade), the cost of solid rocket fuel for two tanks is $1.4 million and for the tank with, liquid fuel the cost is 2, $1 million, a total of $3.5 million. Also, recent systems partially reusable for sending to Low Earth Orbit (LEO) with “Falcon 9” rockets, Space X—NASA, maximum costs are $35 million for fuel launches—as liquid oxygen (LOX) or kerosene. without rocket water (RP1)—for a single launch and total project costs of $1.6 billion, costs close to the costs of launching a classic Saturn V-USA rocket from the 1970s.

Airplanes have in addition to the amount of fuel needed for the formation planes and the initial reserves (at departure), used in the utilitarian aviation flight, meaning “Block Fuel” consisting of: “Trip Fuel” (consumption from take-off to landing), “Contingency Fuel” (regular fuel consumption plus 5% of the entire tank), “Extra Fuel”, “Taxi Fuel” (in winter), “Alternate Fuel” (extra fuel for an initially chosen alternative airport), “Final Reserve Fuel (13 minutes reserve)”. “Trip Fuel” consumption from take-off to landing is also calculated according to the planes of grouping of lower order as altitude but also higher, grouped in climb or collection or independently depending on the calculated altitude.

For the airplanes in the group from the troposphere A2, A B, the costs of fuels “Final Reserve Fuel (13 minutes reserve)”, up to 105000 feet (3.2 km) will be higher due to the air resistance compared to the upper level. An extra kg number will be taken into account and “Extra Fuel” will be used for these aircraft more than for commercial aircraft. They will deliver less fuel than the higher level aircraft A1n, Bn, A3, D, with low forwarding resistance.

1. Air transport device (A2, A4, A-An, B-Bn, A1-A1n, A3, D) characterized by the fact that, in the space of the atmosphere of a planet (D), a flight is being formed simultaneously with other aircraft. flight (A4, A2, A, An, B, Bn), towards and from the outer space of dense atmospheres (D), suitable for space flight devices (A3) with aerodynamic load that are connected to each other to feed each other (A, P, P1, An), also carrying out another transport.

2. An air transport device as in claim 1, characterized in that, they use for fuel supply hoses (P1) with power in ascending direction, from the lower flight apparatus (A1, B), to the upper one from the altitude. married (A1n, Bn).

3. An air transport device as in claim 2, characterized in that it uses, for easy supply, the capillary of the hoses by applying the low pressure from the upper flight apparatus (An), to the lower one as altitude (A).

4. Air transport device as in claim 3, characterized in that they use for conical hose supply with a larger base, as a counterweight (P1), covered with a solid arm, with a boom refueling connection.

5. An air transport device as in claim 3, characterized in that, they use for conical hose supply with a larger base, as a counterweight (P1), with connection with a “house and drogue” funnel.

6. An air transport device as claimed in claims 4 and 5, characterized in that, they use for fuel already hoses primed with fuels (P1) lowered from the plane above the high altitude formation (A1n, Bn).

7. Air transport device as in claim 6, characterized in that it forms a formation flight in the direction of Coriolis force in the hemisphere corresponding to the attraction of the planet's force (A2, A, An, B, Bn), with vertical hoses between 600-1001 meters (P1).

8. An air transport device as in claim 1, characterized in that they use for the supply of light beams (electrically, atomically, thermally or solar), laser diodes (P).

9. Air transport device as in claim 1, characterized in that, they use vibration-generated fuel droplets at reduced pressure (P),

10. Air transport device as in claim 1, characterized in that, they use for power supply cables (P).

11. Air transport device as in claim 1, characterized in that, they use for solid power supply cables (P) for the transport of a physical good with a self-supporting lift (A3, Bn, B).

12. Air transport device as in claim 7, 8, 9, 10, 11 characterized in that, for the transport of a physical good, a self-supporting lift (A3, A1n, B, A, A2, A4) at the same time as power supply (P):

13. Air transport device as in claim 1, characterized in that they have speeds up to 1224.8 km/hour (1 mach),

14. An air transport device as in claim 1, characterized in that they have speeds over 1224.8 km/hour (1 mach),

15. An air transport device as in claim 1, characterized in that, in a circle formation, it forms a concentric flight at high speed, (A1, A1n, A3), maintaining the position of the forward flight, connected (P1, P) with the rest of the band reaching its speed (A4, A2, A-An, B-Bn).

16. An air transport device as in claim 15, characterized in that the static ((A2)) (F) tankers ((A))(A2) are separated by a minimum of 3 flight devices (A, An, B, Bn), connecting −It is with the fuel station flight devices (A4) with ground (M) that form a concentric flight at high speed, maintaining the position of the forward flight, connected (P1, P).
